(19) United States
(12) Patent Application Publication
(10) Pub. No.: US 2024/0262237 A1
(43) Pub. Date: Aug. 8, 2024

(54) ELECTRIC VEHICLE CHARGING CERTIFICATION AND VERIFICATION

(71) Applicant: LIIKENNEVIRTA OY / VIRTA LTD, Helsinki (FI)

(72) Inventor: Jussi AHTIKARI, Helsinki (FI)

(73) Assignee: LIIKENNEVIRTA OY / VIRTA LTD, Helsinki (FI)

(21) Appl. No.: 18/697,543

(22) PCT Filed: Sep. 19, 2022
(86) PCT No.: PCT/FI2022/050621

§ 371 Date: Apr. 1, 2024

(30) Foreign Application Priority Data
Oct. 1, 2021 (FI) 20216023

(51) Int. Cl. B60L 53/66; B60L 53/30

(52) U.S. Cl. CPC B60L 53/665; B60L 53/305

(57) ABSTRACT

Computing device, a system and a method for verifying electric vehicle, EV, charging, is provided. There is received, by Internet based communication such as API, encrypted energy readings certifying and verifying an amount of an energy that an electric vehicle, EV, is charged from an EV charging station, CS. Transmitting these energy readings, by the Internet based communication such as a web server, to be presented to a user who has charged the EV at the CS, wherein said energy readings is configured to be outputted to the user by the Internet-based user interface. Regulations, such as Eichrecht, compatible charging system can be conveniently updated to existing or new parts of the charging system without an individual or manual certification process.

### TECHNICAL FIELD

Various example embodiments generally relate to the field of electric vehicle charging. In particular, some example embodiments relate to verifying and certifying charging of electric vehicle.

### BACKGROUND

Charging stations, CSs, are used to charge electric vehicles, EV. CSs are controlled remotely by a charging station management system, CSMS. Open charge point protocol, OCPP, is a communication protocol between CS and CSMS.

Eichrecht is a German legislation, which regulates how CS's energy usage must be measured in a certified and reliable way. Eichrecht says that encrypted energy readings, so called “signed meter values”, SMVs, must be given for customers so that customers can verify that they are invoiced correct amount of energy.

Eichrecht finds only KWh consumption-based billing as fair: Consequently, pure time-based tariffs (per-minute billing) and flat-rate session fees per charging process (per-session billing) will not be permitted. Eichrecht uses only fully regulated calibration and end-to-end data security of charging data: This means that the CSs will have the fully calibrated KWh measuring meters and should assure the user a reliable, trustworthy transaction, in line with the requirements set by law.

Typical way to fulfil Eichrecht regulation is to send a receipt or invoice of a charge to a customer, usually by email or by paper invoice. This receipt or invoice then includes the SMVs for each charging transaction. After customers receive a receipt with SMVs, they can use a transparency software to verify that they were invoiced a correct amount.

However, sending the receipts requires that customers have a registered customer account with contact information so that charging operator companies know where they can send the receipts or invoices.

Payment terminals, PT, is a traditional fuel chain setup. FIG. 1 shows a fuel pump 1, PT 2 and a receipt printed or electronic receipt 3. PTs are becoming more common in EV charging. FIG. 1 shows an alternative CS 4 that may be used instead of fuel pump 2 for charging EV. Customers can pay with credit or debit card directly using PT 2. However, this creates a problem with Eichrecht: PT payments are handled with payment service providers and card issuers. As a company providing EV charging and owning charging stations, you don't get access to personal information of the person who paid for charging. This makes fulfilling Eichrecht difficult: if you don't know customer's identity, how can you send SMVs to a customer in a reasonable and convenient way.

This is a problem especially each time there is any new hardware changes or integrations to CS: One needs new a Eichrecht certification. All this is slow and expensive. Eichrecht certification can take months, sometimes a year. It means that adding payment terminals to existing stations would be difficult, cumbersome and time consuming, since one would need to certify thousands of existing stations again—one by one individually.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide verification and certification of charging of EV. The objective is achieved by the features of the independent claims. Some embodiments are described in the dependent claims.

According to a first aspect, a computing device comprises: at least one processor; and at least one memory including computer program code. The at least one memory and the computer code configured to, with the at least one processor, cause the computing device at least to: Receive by an application protocol interface, API), data information comprising encrypted energy readings certifying and verifying an amount of an energy that an electric vehicle, EV, is charged from an EV charging station, CS. Provide said data information to a web server configured to be presented to a user who has charged the EV at the CS, wherein said data information is configured to be outputted to the user by a web-based user interface (21) interacting with the web server. For example, an embodiment may enable using an existing charging hardware with no substantial changes. PTs can be added to existing old CSs, and still device can easily provide Eichrecht compliancy without a need to have new long and expensive certification process.

According to an embodiment, the data information comprises signed meter values, SMVs. SMVs can be utilized to integrate energy delivery regulation and certification into various existing and new CSs.

According to an embodiment, the data information further includes payment card information that is used for charging the EV at the CS. This can be utilized to integrate energy delivery regulation and certification into various existing and new CSs.

According to an embodiment, the data information comprises Eichrecht data information. For example, Eichrecht compliant system may be conveniently integrated into the charging system.

According to an embodiment, the data information comprises a link to the Eichrecht data information. For example, only a link without the Eichrecht information can be delivered to user for later use.

According to an embodiment, the device is further configured to receive identifying information of a charging event corresponding to the readings, and transmit the data information corresponding to the identifying information to the UI. For example, only the UI identified with respect to the CS is provided with the regulation information.

According to an embodiment, after the computing device receives information from a charging station management system, CSCS, of a new charge, the computing device is configured to check which UI device is logically linked to the CS where the charge happened, and to send the data information to the checked UI. For example, only the appropriate user receives the energy readings.

According to a second aspect, a system is configured for verifying electric vehicle, EV, charging. The system comprises a charging station management system, CSMS), configured to obtain encrypted energy readings certifying and verifying an amount of an energy that an electric vehicle, EV, is charged at a charging station, CS. The CSMS is further configured to send the readings to a computing device by Internet based communication. The computing device is configured to store the readings and to send, by the Internet based communications, the readings to a user interface, UI), of a user who has charged the EV at a charging station, CS, of the CSMS. The UI is configured to output the readings for the user. For example, an embodiment may enable using an existing charging hardware with no substantial changes. PTs can be added to existing old CSs, and still device can easily provide Eichrecht compliancy without a need to have new long and expensive certification process.

According to an embodiment, the UI is further configured to show the readings to the user, the system further including a transparency software configured to verify the readings and the amount of the energy that EV is charged to the user. For example, the user can verify correct energy meters for EV charging, such as SMVs.

According to an embodiment, the system further comprises a payment terminal, PT, configured to send a charging payment message to the CSMS. For example, an existing or new PT may be added to the system without certification process for energy readings.

According to an embodiment, the CSMS is further configured to send a charging enablement message to the CS. The CSMS is further configured to receive a charging end message and the readings from the CS. For example, the system can control exiting and new CSs.

According to an embodiment, the CS is further configured to receive a charging enablement message from the CSMS and to send a charging end message to the CSMS after charging has ended. For example, the system can control exiting and new CSs.

According to an embodiment, the UI comprises a screen located at a proximity of the PT and the CS, or the UI comprises a mobile of the user, or wherein the UI comprises a printer configured to print the readings to the user. For example, various UIs may be used to provide the certified energy readings. Integration is convenient without certification process.

According to an embodiment, the UI is configured to present a link to the readings to the user. For example, user may read the energy readings later on.

According to an embodiment, the CSMS informs the computing device that charging on the CS, with a certain payment card, has ended. The computing device is further configured to send the readings to the UI next to the CS. For example, user next to the CS and using personal payment card for charging may observer the readings.

According to a third aspect, a method for verifying electric vehicle, EV, charging, comprises the following. Receiving, by Internet based communication, encrypted energy readings certifying and verifying an amount of an energy that an electric vehicle, EV, is charged from an EV charging station, CS. Transmitting said energy readings, by the Internet based communication, to be presented to a user who has charged the EV at the CS, wherein said energy readings is configured to be outputted to the user by the Internet-based user interface, UI (21). For example, regulations, such as Eichrecht, compatible charging system can be conveniently updated to existing or new parts of the charging system without an individual or manual certification process.

According to a further aspect, a computer program configured, when executed by a computing device, to cause the computing device at least to: Receive, by Internet based communication, encrypted energy readings certifying and verifying an amount of an energy that an electric vehicle, EV, is charged from an EV charging station, CS (4). Transmit said energy readings, by the Internet based communication, to be presented to a user who has charged the EV at the CS, wherein said energy readings is configured to be outputted to the user by the Internet-based user interface, UI (21).

Many of the attendant features will be more readily appreciated as they become better understood by reference to the following detailed description considered in connection with the accompanying drawings.

### BRIEF DESCRIPTION OF THE DRAWINGS

The accompanying drawings, which are included to provide a further understanding of the example embodiments and constitute a part of this specification, illustrate example embodiments and together with the description help to explain the example embodiments. In the drawings:

FIG. 1 illustrates an example of OTP setup, according to a comparative example;

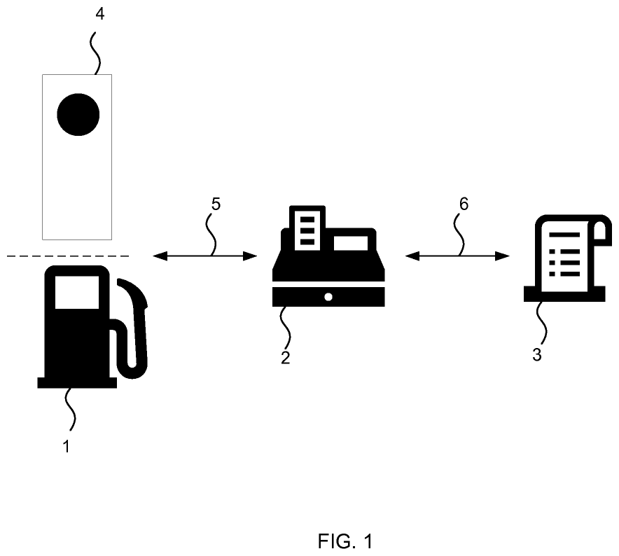

FIG. 2 illustrates an example of a computing device configured to charging energy readings portal, according to an example embodiment;

FIG. 3 illustrates an example of a system having an Eichrecht portal, according to an example embodiment;

FIG. 4 illustrates an example of a charging summary information, according to an example embodiment;

FIG. 5 illustrates an example of architecture of Eichrecht portal, according to an example embodiment;

FIG. 6 illustrates an example of a data model of system having Eichrecht portal, according to an example embodiment;

FIG. 7 illustrates an example of signalling diagram for certified charging, according to an example embodiment;

FIG. 8 illustrates an example of a system having an Eichrecht portal using mobile of user, according to an example embodiment;

FIG. 9 illustrates an example of a system having an Eichrecht portal using mobile of user, according to another example embodiment;

FIG. 10 illustrates an example of a search interface of Eichrecht information, according to an example embodiment; and

FIG. 11 illustrates an example of a system having an Eichrecht portal with a printer, according to an example embodiment.

In the following, like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of operations for constructing and operating the example. However, the same or equivalent functions and sequences may be accomplished by different examples.

It is all the time more common that CS is connected to PT. When customers pay for charging using an PT, system do not know customer's name, email or other contact information. At the same time, CSs are required by certification and verification regulations, such as the Eichrecht-law in Germany, to send charging energy readings, such as signed meter values, SMV, to customers after charging ends.

An embodiment solves how the system can send SMVs to customers after charging ends, even if the system does not know customers contact information. The system may be configured to perform this without any substantial hardware-level changes or hardware-level integration between CSs and PTs. In fact, any hardware-integration is intended to be avoided, since that would require a new long and expensive certification process.

In the embodiment, integration is not done on a hardware level, but the computing portal device is configured to enable Eichrecht information without any hardware changes to existing CSs and existing PT terminals.

An embodiment is configured to send information fulfilling the certification regulations to a customer without any hardware changes to CSs. The certification regulation information may be charging energy readings, such as SMVs or any other Eichrecht or regulation information. Consequently, the system may use various existing hardware in the market. There is no need for any substantial hardware changes to PTs. The system is flexible for various existing hardware in the market. The CMCS may be configured to use existing hardware without need to Eichrecht-certify it every time a change is made.

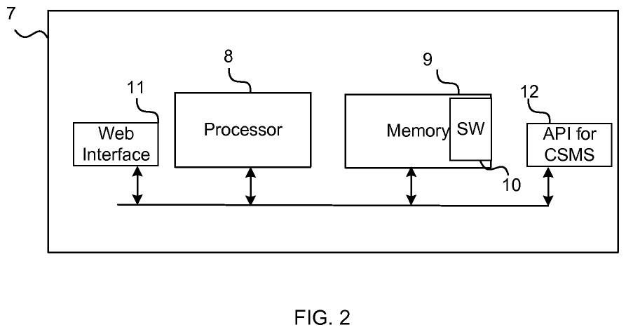

FIG. 2 illustrates an example of a computing device 7 configured to control certification information, according to an example embodiment. The computing device 7 may be referred to as a portal. The device 7 may be a cloud-based central portal configured for the certification information and a web-based interface for it.

There are many ways to access the web-based interface. Physical screen next to CS where the information is pushed automatically after charging ends. Possibility to access the same information with a device that has a web browser, like mobile phones. Possibility to show link to the info on PTs screen, if PT supports this. Possibility to search the information later based on payment card details

According to an embodiment, customers have possibility to order the certification information to their email. If there is a physical screen next to CS it may also be equipped with a printer, so the customer can choose to print the charging energy readings, such as SMVs, instead of getting them by email.

The embodiment may be configured without hardware level integration. The embodiment may be configured having a fully cloud-based integration.

FIG. 2 illustrates an example embodiment of computing device 7 for managing certification and verification information for meeting regulations for appropriate charging. The device 7 may comprise at least one processor 8. The at least one processor may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The device 7 may further comprise at least one memory 9. The memory 9 may be configured to store, for example, computer program code 10 or the like, for example operating system software and application software. The memory may comprise one or more volatile memory devices, one or more non-volatile memory devices, and/or a combination thereof. For example, the memory may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The device 7 may further comprise communication interface 11 configured to enable the device 7 to transmit and/or receive information, to/from other devices. The communication interface 11 may be configured to provide at least a web-based interface, acting for example as a web server. The communication interface 11 may be a wireless radio connection, such as for example a 3GPP mobile broadband connection (e.g. 3G, 4G, 5G). However, the communication interface 11 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. Communication interface 11 may comprise, or be configured to be coupled to, at least one antenna to transmit and/or receive radio frequency signals. One or more of the various types of connections may be also implemented as separate communication interfaces, which may be coupled or configured to be coupled to a plurality of antennas.

The device 7 may further comprise application protocol interface, API, 12 configured for CSMS. The API for CSMS 12 is configured to connection between the device 7 and CSMS. It receives data from CSMS.

When the device 7 is configured to implement functionality, some component and/or components of the device 7, such as for example the at least one processor 8 and/or the memory 9, may be configured to implement this functionality. Furthermore, when the at least one processor 8 is configured to implement some functionality, this functionality may be implemented using program code 10 comprised, for example, in the memory 9.

The functionality described herein may be performed, at least in part, by one or more computer program product components such as software components. According to an embodiment, the device comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), Systemon-a-chip systems (SOCs), Complex Programmable Logic Devices (CPLDs), Graphics Processing Units (GPUs).

The device 7 comprises means for performing at least one method described herein. In one example, the means comprises the at least one processor 8, the at least one memory 9 including program code 10 configured to, when executed by the at least one processor 8, cause the device 7 to perform the method.

The device 7 may comprise for example a server device. Although the device 7 is illustrated as a single device it is appreciated that, wherever applicable, functions of device 7 may be distributed to a plurality of devices. In an embodiment, the device 7 may comprise a cloud-based Eichrecht portal.

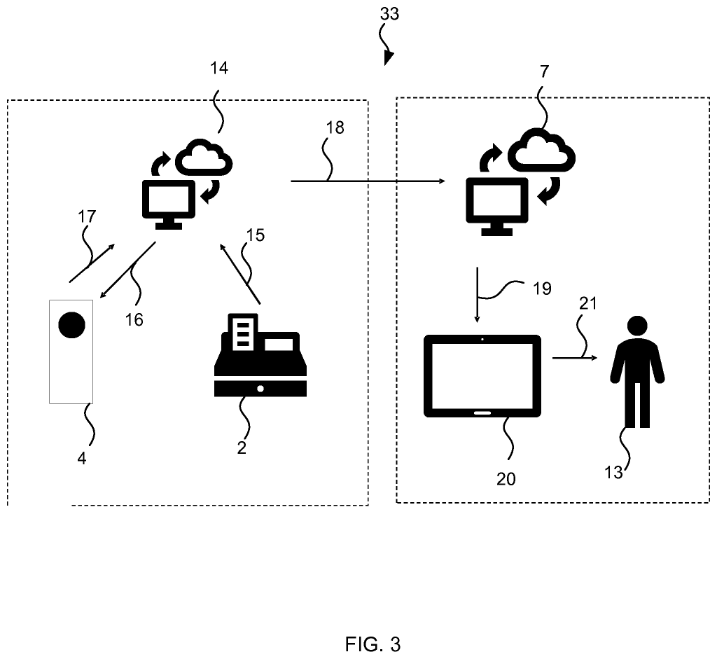

FIG. 3 illustrates an example embodiment of system 33 having an anonymous cloud-based Eichrecht portal 7 where anonymous customers 13 paying with an PT 2 can see their Eichrecht information.

Customer 13 pays for charging with an PT 2. PT 2 informs CSMS 14 about the payment at operation 15.

At operation 16 CSMS 14 starts charging on a CS 4

After charging for a while, the customer 13 stops charging. At operation 17 the CS 4 sends stop-message to the CSMS 14, including SMVs.

Customer 13 pays for charging at operation 15, starts charging at operation 16, and after charging is ready, stops charging at operation 17.

As a result, the CSMS 14 gets the following information from the CS 4: a) Signed meter values, SMVs of the individual charging event, b) payment token identifying the payment card used for payment, and 4 last digits and expiration time of the payment card.

At operation 18 CSMS 14 informs Eichrecht portal 7 that charging on a (certain) CS 4, with (certain) payment card, has ended. When CSMS 14 receives a SMVs as a part of OCPP StopTransaction—message, it will wait for StatusNotification=Available—message, which tells that customer 13 has how disconnected the EV from the CS 4. After this CSMS 14 sends these SMVs, together with payment card info, to the cloud-based Eichrecht portal 7.

At operation 19 Eichrecht portal 7 pushes this information to Eichrecht Screen 20, which may be situated next to a CS 4. Each Eichrecht compliant CS 4 with PT 2 is logically linked by the Eichrecht portal 7 to a Eichrecht Screen 20, which may be located physically next to CS 4.

At operation 21 customers 13 can see the Eichrecht information, including SMVs, on the screen 20. Customer 13 may also order this information to their email if they wish to do so. After Eichrecht portal 7 receives information from CSMS 14 of a new charge, it checks which Eichrecht screen 20 is logically linked to the CS 4 where the charge happened in, and sends this information to the screen 20 where it is shown to the customer 13.

If the customer 13 wants, the customer 13 can then also to order this info to his/her email address, and the Eichrecht portal 7 then send the receipt with SMVs to customer's email.

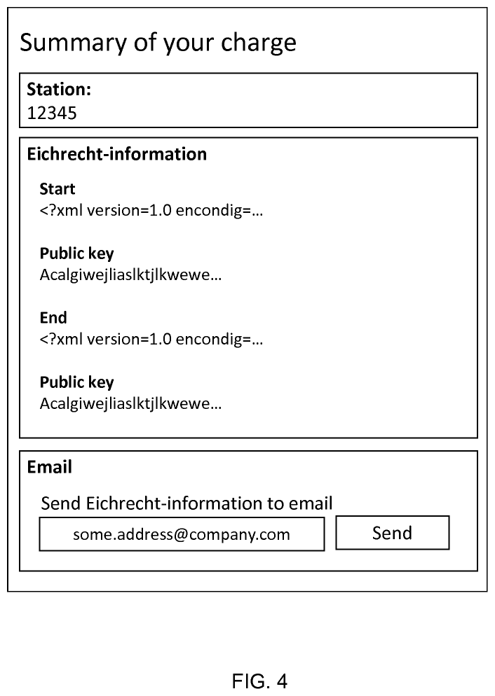

FIG. 4 illustrates an example of Eichrecht screen mockup with information push according to an embodiment. This information is pushed to the screen 20 automatically after charging ends and the customer 13 disconnects cable from the EV. It shows summary of charge having CS identity, Eichrecht information of the charging event, and email of customer 13. Customer 13 may interact accordingly with screen 20.

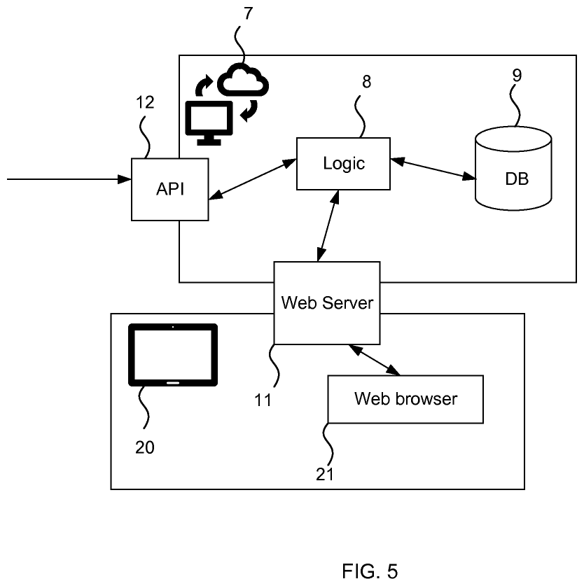

FIG. 5 illustrates an embodiment of Eichrecht portal 7 and Eichrecht screen 20 architecture.

Computing portal device 7 comprises processor 8 and a memory 9 for example a Eichrecht database. Eichrecht portal 7 has functionality to save charging information, including SMVs and payment card info, to a central database 8. Portal device 7 comprises also API 12 for CSMS 14. API 12 received data from CSMS 14. Portal device 7 comprises web interface 11 such as web server. Eichrecht-portal 7 serves this information through web-based interface 11. The information can be used by various web browsers 21: either with special onsite-screens, or also with any device with a web browser, for example mobile phone. The Eichrecht screen 20 can be a simple computer with a web-browser 21 that connects to the Eichrecht portal 7. It doesn't need to have any more logic or functionality than just opening a certain web page for Eichrecht information.

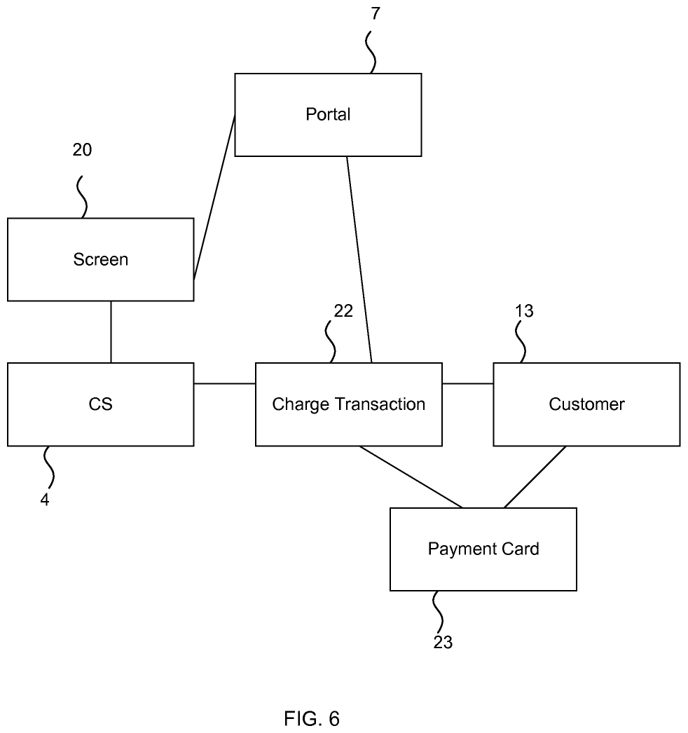

FIG. 6 illustrates an embodiment of data model of the Eichrecht system. Eichrecht portal 7 is logically connected to Eichrecht Screen 20 and charge transaction 22 having the SMVs. Charge transaction 22 is logically connected to customer 13 and payment card 23, naturally customer 13 has the payment card 23. Charge transaction 22 is logically connected to CS 4 and to Eichrecht portal 7. Charging station 7 is logically connected to Eichrecht screen 20.

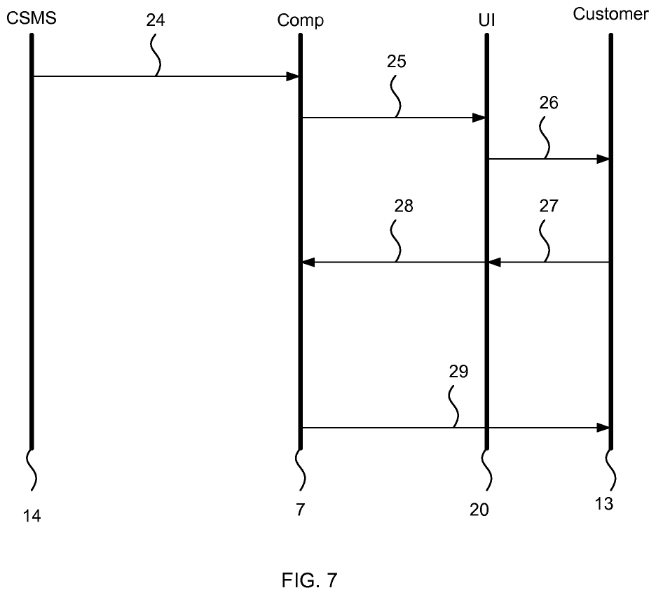

FIG. 7 illustrates signalling or process diagram of certifying and verifying EV charging operation by Eichrecht portal device 7. At operation 24, CSMS 14 sends SMVs of a single charge operation, which happened on single charging station 4, to the Eichrecht-portal 7. At operation 25, portal device 7 checks which screen is logically linked to the charging station 4. Eichrecht portal 7 sends the Eichrecht information to the correct screen 20. At operation 26, screen 20 shows Eichrecht information to the customer 13. At operation 27, customer 13 enters email to order the Eichrecht information. At operation 28, email order is submitted to the portal device 7. At operation 29, the portal device sends Eichrecht information to the customer 13 by email.

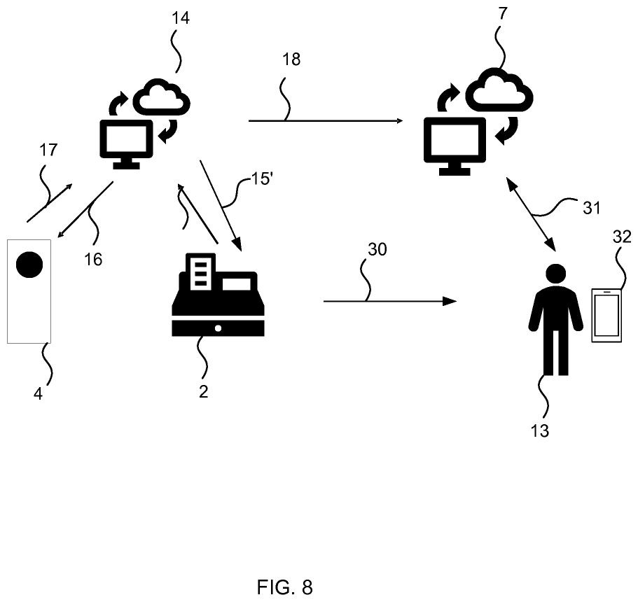

FIG. 8 illustrates an embodiment of certifying EV charging operation.

PT 2 may be configured to show a short message after the charging has ended. In this case there is no need for a separate Eichrecht screen 20. At operation 15′, the CSMS 14 shows a message on the PT screen “Get Eichrecht-information at for example http://chge.eu/r/ABC123”, which is link to the Eichrecht portal 7. The last part of the link 30, 31 (“ABC123” in the example) is a unique identifier for a single Eichrecht-information of a single charge. The customer 13 can then open this link 30,31, for example to their mobile phone 32 or any other device with web browser 21, and then see the Eichrecht information. In the embodiment of FIG. 8 screen in not required, but mobile 32 and a link 30,31 to the Eichrecht information may be used.

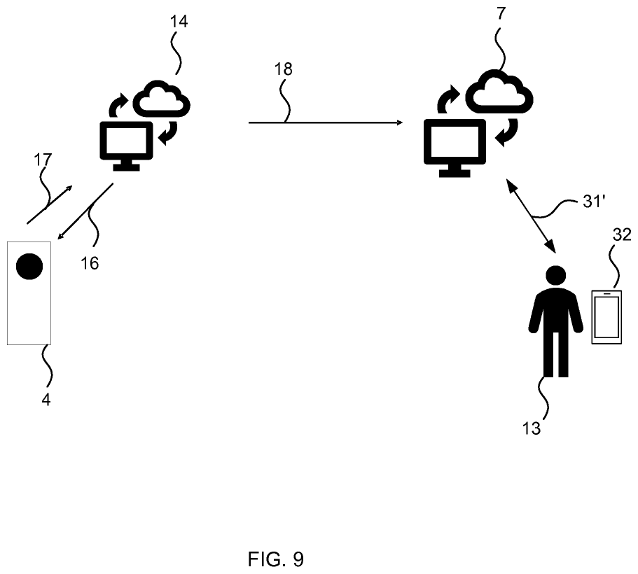

FIG. 9 illustrates an embodiment of certifying EC charge operation that may be configured to find the Eichrecht information later. Sometimes customers 13 forget to check or order the Eichrecht information to the email immediately, but would want to access the information later, for example next day. Customer 13 has instructions, for example on web page of the CS 4 owner or on a sticker on the CS 4, how to access Eichrecht info. Customer 13 can open link 31′ to the Eichrecht portal 7 and search for Eichrecht information. If there are charge operations found with the criteria the customer 13 has given, then Eichrecht information is shown to the customer 13. Mobile 32 of customer 13 may illustrate charging operation.

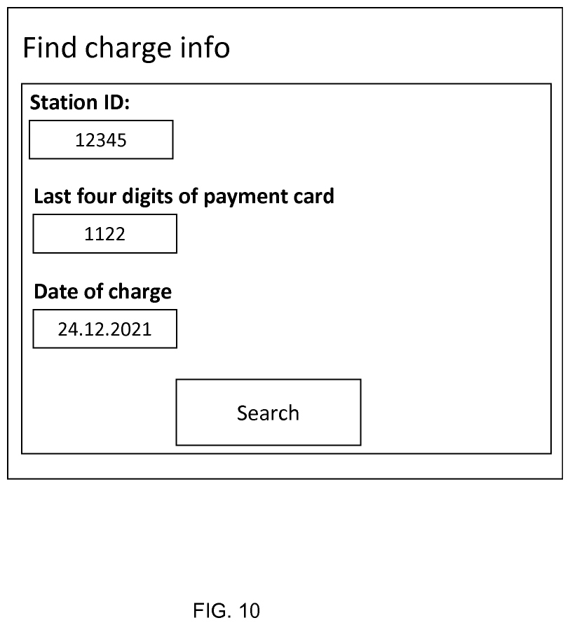

FIG. 10 illustrates embodiment of Eichrecht information search user interface to customer 13. If customer 13 wants to fetch Eichrecht information later, customer 13 can do it with a simple UI. If Eichrecht-information is found with this criterion, then link to the information may be presented to customer 13. Finding charge information comprises station id, last four digits of payment case and date of charge. This searching user interface may be used to search Eichrecht information corresponding to search terms.

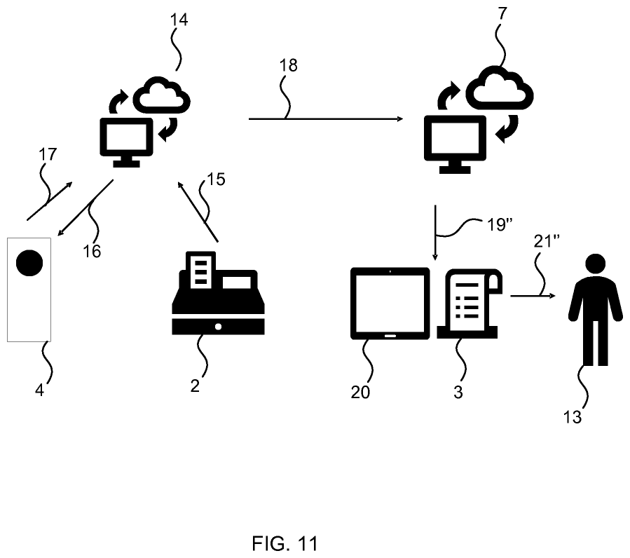

FIG. 11 illustrates an embodiment of Eichrecht screen 20 with printer 3. Eichechht screen 20 can be also combined with printer 3, which prints the Eichrecht information on the paper or receipt, for example similarly as receipt printers used in various places. When charging ends, Eichrecht information may be show on screen 20. However, instead of ordering the Eichrecht information to email, the customer 13 can choose to print the information. In this case the same Eichrecht information, which is shown on the screen 20, is printed to paper using a printer 3 attached to the screen 20.

Further features of the method(s) directly result for example from functionalities of the computing device described throughout the specification and in the appended claims and are therefore not repeated here. Different variations of the method(s) may be also applied, as described in connection with the various example embodiments. It is obvious to a person skilled in the art that with the advancement of technology, the basic idea of the disclosure may be implemented in various ways. The disclosure and the embodiments are thus not limited to the examples described above, instead they may vary within the scope of the claims.

A computing device may be configured to perform or cause performance of any aspect of the method(s) described herein. Further, a computer program may comprise instructions for causing, when executed, a device to perform any aspect of the method(s) described herein. Further, a device may comprise means for performing any aspect of the method(s) described herein. According to an example embodiment, the means comprises at least one processor, and memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or device may contain additional blocks or elements.

The terms ‘automated’, ‘automatically’, ‘automatic’ and variations thereof, as used herein, may refer to any process or operation done without human input when the process or operation is performed. However, a process or operation can be automatic, even though performance of the process or operation uses human input, if the input is received before performance of the process or operation.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A computing device, the computing device comprising:
at least one processor; and
at least one memory including computer program code;
the at least one memory and the computer code configured to, with the at least one processor, cause the computing device at least to:
receive by an application protocol interface, API, data information comprising encrypted energy readings certifying and verifying an amount of an energy that an electric vehicle, EV, is charged from an EV charging station, CS;
wherein said data information further includes at least a portion of last digits of a payment card that is used for charging the EV at the CS and a CS identity, wherein the portion of the last digits of the payment card and the CS identity are configured to associate to the encrypted energy readings certifying and verifying the amount of the energy charged;
after the computing device receives information from a charging station management system, CSMS, of the charge, based on said data information the computing device is further configured to check which web-based UI device is logically linked to the CS where the charge happened;
provide said data information to a web server configured to be presented to anonymous user who has charged the EV at the CS, wherein said data information is configured to be outputted to the anonymous user by the web-based UI device interacting with the web server.

2. The computing device of claim 1, wherein said data information comprises signed meter values SMVs.

3. The computing device of claim 1, wherein said data information further includes payment card information that is used for charging the EV at the CS.

4. The computing device of claim 1, wherein said data information comprises Eichrecht data information.

5. The computing device of claim 1, wherein said data information comprises a link to Eichrecht data information.

6. The computing device of claim 1, further configured to receive identifying information of a charging event corresponding to the readings, and transmit the data information corresponding to the identifying information to the user interface.

7. (canceled)

8. A system for verifying electric vehicle, EV, charging, comprising:
a charging station management system, CSMS, configured to obtain encrypted energy readings certifying and verifying an amount of an energy that an electric vehicle, EV, is charged at a charging station, CS;
the CSMS further configured to send the readings to a computing device by Internet based communication;
the computing device configured to store the readings and to send, by the Internet based communications, the readings to a user interface, UI, of anonymous user who has charged the EV at a charging station, CS, of the CSMS; and
the UI configured to output the readings for the anonymous user;
wherein said data information further includes a portion of the last digits of a payment card that is used for charging the EV at the CS and a CS identity, wherein the portion of the last digits of the payment card and the CS identity are configured to associate to the encrypted energy readings certifying and verifying the amount of the energy charged.

9. The system of claim 8, wherein the UI is configured to show the readings to the user, the system further including a transparency software configured to verify the readings and the amount of the energy that EV is charged to the user.

10. The system of claim 8, further comprising a payment terminal, PT, configured to send a charging payment message to the CSMS.

11. The system of claim 8, wherein the CSMS is further configured to send a charging enablement message to the CS; and to receive a charging end message and the readings from the CS.

12. The system of claim 8, wherein the CS is further configured to receive a charging enablement message from the CSMS and to send a charging end message to the CSMS after charging has ended.

13. The system of claim 8, wherein the UI comprises a screen located at a proximity of a payment terminal, PT, and the CS; or wherein the UI comprises a mobile of the user; or wherein the UI comprises a printer configured to print the readings to the user.

14. The system of claim 8, wherein the UI is configured to present a link to the readings to the user.

15. The system of claim 8, wherein the CSMS informs the computing device that charging on the CS, with a certain payment card, has ended;
the computing device is further configured to send the readings to the UI, wherein the UI is located next to the CS.

16. A method for verifying electric vehicle, EV, charging, comprising:
receiving, by Internet based communication, data information comprising encrypted energy readings certifying and verifying an amount of an energy that an electric vehicle, EV, is charged from an EV charging station, CS, wherein said data information further includes a portion of the last digits of a payment card that is used for charging the EV at the CS and a CS identity, wherein the portion of the last digits of the payment card and the CS identity are configured to associate to the encrypted energy readings certifying and verifying the amount of the energy charged; and
based on said data information checking which Internet-baser user interface device is logically linked to the CS where the charge happened and transmitting said energy readings, by the Internet based communication, to be presented to anonymous user who has charged the EV at the CS, wherein said energy readings is configured to be outputted to the user by the Internet-based user interface, UI.

17. A computer program configured, when executed by a computing device, to cause the computing device at least to:
receive, by Internet based communication, data information comprising encrypted energy readings certifying and verifying an amount of an energy that an electric vehicle, EV, is charged from an EV charging station, CS, wherein said data information further includes a portion of the last digits of a payment card that is used for charging the EV at the CS and a CS identity, wherein the portion of the last digits of the payment card and the CS identity are configured to associate to the encrypted energy readings certifying and verifying the amount of the energy charged; and
based on said data information check which Internet-based user interface device is logically linked to the CS where the charge happened and transmit said energy readings, by the Internet based communication, to be presented to anonymous user who has charged the EV at the CS, wherein said energy readings is configured to be outputted to the user by the Internet-based user interface, UI;
wherein said data information further includes a portion of the last digits of a payment card that is used for charging the EV at the CS and a CS identity, wherein the portion of the last digits of the payment card and the CS identity are configured to associate to the encrypted energy readings certifying and verifying the amount of the energy charged.
